(19) United States
(12) Patent Application Publication
(10) Pub. No.: US 2017/0256828 A1
(43) Pub. Date: Sep. 7, 2017

(54) THERMAL MANAGEMENT SYSTEM OF BATTERY PACK

(71) Applicant: Contemporary Amperex Technology Co., Limited, Ningde (CN)

(72) Inventors: Zhiyun LI, Ningde (CN); Ruobo YOU, Ningde (CN)

(21) Appl. No.: 15/231,682

(22) Filed: Aug. 8, 2016

(30) Foreign Application Priority Data
Mar. 7, 2016 (CN) 201610127135.3

(51) Int. Cl. H01M 10/613; H01M 10/63; H01M 10/625; H01M 10/6554; H01M 10/6569

(52) U.S. Cl. CPC H01M 10/613; H01M 10/6554; H01M 10/6569; H01M 10/625; H01M 10/63; H01M 2220/20

(57) ABSTRACT

A thermal management system of a battery pack, including a cooling plate, a condensation plate and a gas-liquid phase change medium, the cooling plate includes a top plate, a first lateral plate and a second lateral plate, The top plate, the first lateral plate and the second lateral plate together form an accommodating cavity for containing a battery module, the top plate is arranged at the top of the accommodating cavity, the first lateral plate and the second lateral plate are respectively arranged at two sides of the accommodating cavity, the first lateral plate and the second lateral plate are both of a hollow cavity structure, the gas-liquid phase change medium is contained in the hollow cavity structure, the condensation plate is arranged above of the top plate and forms a cavity together with the top plate, the cavity is communicated with the hollow cavity structure.

### TECHNICAL FIELD

The present application relates to a thermal management system of a battery pack, particularly to a thermal management system of a battery pack applied to heat exchange.

### BACKGROUND

Chinese patent invention No. 104617352 discloses a build-in radiating device of a battery pack for electric vehicles. The radiating surfaces of two sides of each single battery in the battery pack are connected with a multi-channel microgroove composite phase change radiating module. The multi-channel microgroove composite phase change radiating module is an I-shaped radiating module composed of a cavity connected with two fins at both sides thereof. The radiating surfaces at two sides of the single battery are connected with the cavity, respectively. Each two multi-channel microgroove composite phase change radiating modulesare alternatively arranged and contact with each other to form a column. A channel gap which facilitates flowing of air or insulative cooling liquid is provided between adjacent two columns. The single battery and the multi-channel microgroove composite phase change radiating module are installed in the battery packbox, both the upper surface and the lower surface of the battery packbox are provided with an air hole or an liquid inlet opening and an liquid outlet opening of the insulative cooling liquid.

At present, the battery pack in the market is generally cooled using the thermal management system of air cooling or water cooling. The air cooling system uses a fan to blow air onto a battery, so as to exchange heat between air and the battery. The water cooling system uses a water pump to transport the cooling liquid to a battery to exchange heat therewith, the heat is reserved in the cooling liquid temporarily, the heated cooling liquid continues to circulate, and participates circulation after being brought to the radiator to be cooled. Some battery packs use a solid-liquid phase change medium to prevent the battery pack from being in a high temperature, the periphery of the battery is filled with the solid-liquid phase change medium, when the battery is in a high temperature, the heat is transferred to the phase change medium, the solid-liquid phase change medium will absorb a large amount of heat when converting from solid state to liquid state. The thermal management system of air cooling often cannot meet the radiating requirement of the system due to its low efficiency of heat exchange; the water cooling system has a better capability of heat exchange, however, the structure is complex and the cost is high, which occupies large space of the whole vehicle, since temperature difference exists between the inlet-water and the outlet-water, the uniformity between the batteries is poor. The solid-liquid phase change medium generally has poor heat conducting performance, although the ability of heat reserving is provided, however, disadvantage of slow heat transfer also exists.

Therefore, a new thermal management system of a battery pack is a necessity to be provided to overcome the above-mentioned defects.

### SUMMARY

Object of the present application is to provide a heating management system of a battery pack applied to heat exchange.

The object of the present application is achieved by the following technical solutions:

The present application provides a heating management system of a battery pack, including a cooling plate, a condensation plate and a gas-liquid phase change medium, the cooling plate includes a top plate, a first lateral plate and a second lateral plate, the top plate and the first lateral plate and the second lateral plate together form an accommodating cavity for containing a battery module, the top plate is arranged at the top of the accommodating cavity, the first side plate and the second side plate are situated at two sides of the accommodating cavity, both the first lateral plate and the second lateral plate are of a hollow cavity structure, the gas-liquid phase change medium is contained inside the hollow cavity structure, the condensation plate is placed above the top plate and forms a cavity together with the top plate, the cavity is communicated with the hollow cavity structure.

Further, the system further includes a division plate, the division plate is arranged inside the hollow cavity structure of the first lateral plate and the second lateral plate, the division plate divides the hollow cavity structure into a plurality of cooling grooves, each cooling groove is communicated with the cavity.

Further, the system further includes a lower baffle, the lower baffle is arranged at the top plate, which divides the cavity into a plurality of liquid separating areas, each liquid separating area is communicated with the cooling groove, and a gap exists between the lower baffle and the condensation plate.

Further, the system further includes an upper baffle, the upper baffle is arranged on the condensation plate, and a gap exists between the upper plate and the top plate.

Further, the system further includes a balance hole, the balance hole is provided at the division plate, and the balance hole is connected through the cooling grooves at two sides of the division plate.

Further, all the balance holes are of equal height.

Further, the system further includes a separation plate, the separation plate is arranged inside the cavity, which separates the cavity into an independent first cavity and second cavity, the first cavity is communicated with all the cooling grooves of the first lateral plate, the second cavity is communicated with all the cooling grooves of the second lateral plate.

Further, the system further includes a cover of a filling opening and a filling opening, the filling opening is provided on the condensation plate, the cover of the filling opening is sleeved on the filling opening, and the filling opening is communicated with the liquid separating area.

Further, there are multiple filling holes, which are arranged corresponding to the first cavity and the second cavity, respectively.

Further, the condensation is fixedly connected with the top plate through welding.

Comparing to the prior art, the present application possesses the following beneficial effects: the heating management system of the battery pack of the present application achieves that the heat of the battery module is transferred to the condensation plate without the effect of the external force, the structure of the present application is simple and compact, which occupies small space, costs less, the heat exchanging effect is significant and is easy to implement, and can achieve uniform cooling the battery module and possesses good heat conductivity.

### BRIEF DESCRIPTION OF DRAWINGS

FIG. 1 is a schematic diagram of a thermal management system of a battery pack according to the present application;

FIG. 2 is an inclining schematic diagram of the thermal management system of the battery pack according to the present application;

FIG. 3 is an enlarged view of part A in FIG. 2;

FIG. 4 is a structural schematic diagram of a cooling plate according to the present application.

FIG. 5 is a first structural schematic diagram of a condensation plate according to the present application;

FIG. 6 is a second structural schematic diagram of the condensation plate according to the present application.

1. Cooling plate; 101. Top plate; 102. First lateral plate; 103. Second lateral plate; 2. Condensation plate; 3. Gas-liquid phase change medium; 4. Division plate; 5. Cooling groove; 6. Lower baffle; 7. Upper baffle; 8. Balance hole; 9. Separation plate; 10. Cover of filling opening; 11. Filling opening; 12. Battery module.

### DESCRIPTION OF EMBODIMENTS

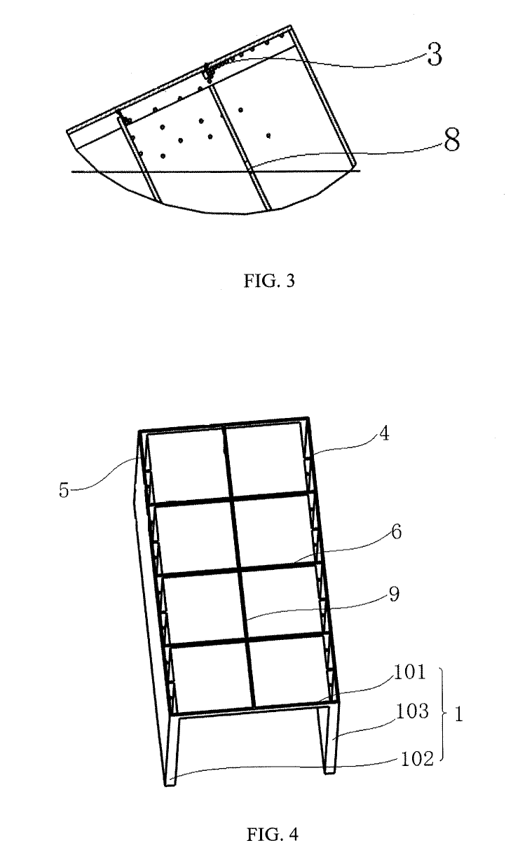

Hereinafter, specific implementing manners of a thermal management system of a battery pack according to the present application will be introduced referring to FIGS. 1-6.

As shown in FIG. 1, the thermal management system of the battery pack provided by the present application includes a cooling plate 1, a condensation plate 2 and gas-liquid phase change medium 3, the cooling plate 1 includes a top plate 101, a first lateral plate 102 and a second lateral plate 103, an accommodating cavity of a battery module 12 is formed by the top plate 101, the first lateral plate 102 and the second lateral plate 103 together, the top plate 101 is located at the top of the accommodating cavity, the first lateral plate 102 and the second lateral plate are located at two sides of the accommodating cavity, the first lateral plate 102 and the second lateral plate 103 are adjacent to or attached to the battery module 12 in the accommodating cavity, the first lateral plate 102 and the second lateral plate 103 are both of a hollow cavity structure, a gas-liquid phase change medium 3 is contained in the hollow cavity structure, which uses the gas-liquid phase change medium solves the problem of poor heat conductivity of the gas-liquid phase change medium, the condensation plate 2 is arranged above the top plate 101, the condensation plate 2 is fixedly connected with the top plate 101 through welding and forms a cavity together with the top plate 101, the cavity is communicated with the hollow cavity structure.

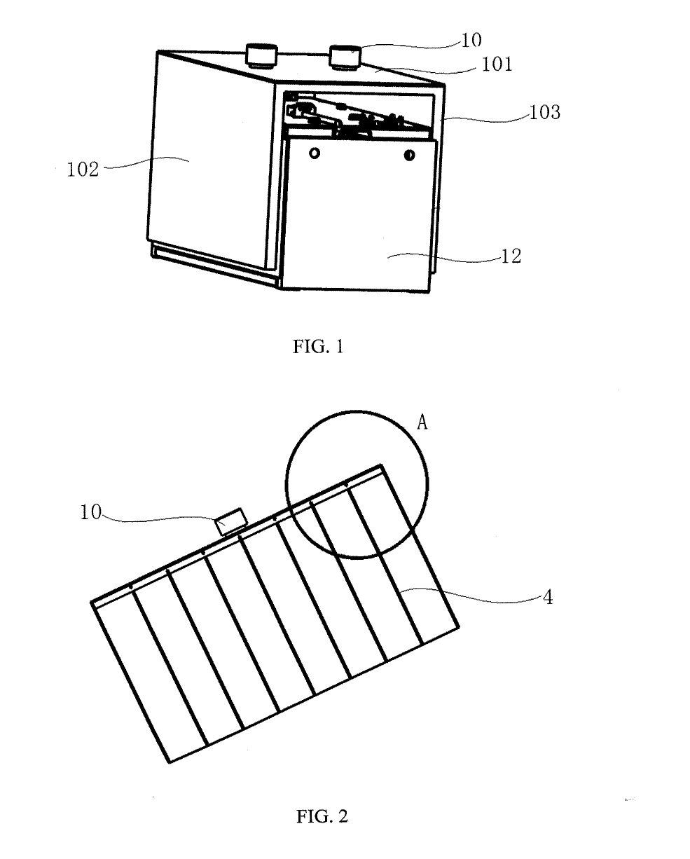

As shown from FIG. 2 to FIG. 4, in order to prevent the problem of non-uniform distribution of the gas-liquid phase change medium 3 when the vehicle is inclining forward and backward or leftward and rightward, in the present application, a division plate 4 is arranged in the hollow cavity structure of the first lateral plate 102 and the second lateral plate 103, the division plate 4 divides the hollow cavity structure into a plurality of cooling grooves 5, and each cooling groove 5 is communicated with the cavity, preferably, the division plate 4 is arranged longitudinally inside the hollow cavity structure. Because of the flow characteristics of the gas-liquid phase change medium 3, the gas-liquid phase change medium 3 in the cooling groove 5 will flow, which causes the non-uniform distribution of the gas-liquid phase change medium 3, the interface of the gas-liquid phase change medium 3 is as flat as horizontal plane, when the vehicle returns to the level road from inclining forward and backward or leftward and rightward, in order to maintain the gas-liquid phase change medium 3 to be uniformly distributed in the cooling groove 5, a balance hole 8 is provided at the division plate 4 in the present application, and each balance hole 8 is provided on the division plate with equal height, so that the gas-liquid phase change medium 3 can be redistributed. The interface of the gas-liquid phase change medium is always higher than the balance hole 8, so that there is sufficient gas-liquid phase change medium 3 in the cooling groove 5 constantly so as to cool the battery module 12.

As shown in FIG. 4, in order to achieve independent cooling of two sides of the battery module 12, the present application also provides a separation plate 9, the separation plate 9 is arranged inside the cavity, and separates the cavity into an independent and closed first cavity and second cavity, the first cavity and the second cavity do not communicate with each other, the first cavity is communicated with each cooling groove 5 of the first lateral plate 102, the second cavity is communicated with each cooling groove 5 of the second lateral plate 103.

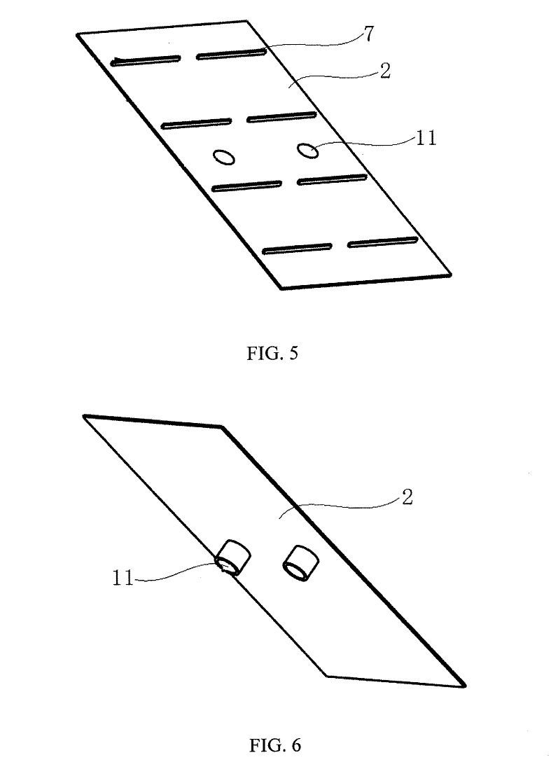

As shown in FIG. 4, in order to obstruct the liquid state substance changed from the gas-liquid phase change medium 3, the present application also provides a lower baffle 6, the lower baffle 6 is arranged at the top plate 101, which separates the cavity into a plurality of liquid separating areas, each liquid separating area is communicated with the cooling groove 5, a gap exists between the lower baffle 6 and the condensation plate 2. As shown in FIG. 5, in order to guide the above-mentioned liquid state substance better, the present application also provides an upper baffle 7, the upper baffle 7 is arranged at the condensation plate 2, a gap exists between the upper baffle 7 and the top plate 101. The upper baffle 7 and the lower baffle 6 are not arranged directly corresponding up and down, but are distributed alternatively, that is, providing an upper baffle 7, then a lower baffle 6 in a distance, and then an upper baffle 7 in another distance, so that a certain distance exists between the upper baffle 7 and the lower baffle 6 in horizontal direction. After the temperature of the battery module 12 reaching the boiling point of the gas-liquid phase change medium 3, and plenty of heat is absorbed, the gas-liquid phase change medium 3 will change from liquid state substance to gas state substance, the gas state substance rises and contacts the condensation plate 2, the condensation plate 2 absorbs the heat of the gas-liquid phase change medium 3, and the gas-liquid phase change medium 3 changes into liquid state substance, the liquid state substance flows downward along the condensation plate 2, and gathers when contacting the upper baffle 7, then falls on the top plate 101 under the effect of gravity, the liquid state substance flows on the top plate 101, then goes into the corresponding liquid separating area after contacting the lower baffle 6, and then flows into the corresponding cooling groove 5. Because a gap exists between the upper baffle 7 and the lower baffle 6, the liquid state substance is obstructed, meanwhile the flow of the gas state substance changed from the gas-liquid phase change medium 3 is implemented. Natural wind, cooling liquid as well as an evaporator of an air condition system can be used to cool the condensation plate 2 as a cold source.

As shown in FIG. 5 and FIG. 6, in order to prevent leakage of the phase change medium and be convenient for filling the gas-liquid phase change medium 3, the present application also includes a cover of filling opening 10 and a filling opening 11, the filling opening 11 is arranged at the condensation plate 2, the cover of the filling opening 10 is arranged sleeved on the filling opening 11, the filling opening 11 is communicated with the liquid separating area. In order to more conveniently fill the gas-liquid phase change medium 3 into the first lateral plate 102 and the second lateral plate 103 which are cooled independently, there can be multiple filling openings in the present application, which are arranged corresponding to the first cavity and the second cavity, respectively. The phase change temperature of the gas-liquid phase change medium 3 filled is between 35° C. to 55° C. When filling the gas-liquid phase change medium 3, a manner of vacuumed filling is adopted to guarantee that only the gas-liquid phase change medium 3 and the gas state substance vapored in low pressure exist in the container.

The above described are only part of the embodiments of the present application, but not all of them, any equivalent variations made by those skilled in the art to the technical solutions of the present application after reading the specification of the present application shall be covered by the claims of the present application.

What is claimed is:

1. A thermal management system of a battery pack, comprising a cooling plate, a condensation plate and a gas-liquid phase change medium, characterized in that: the condensation plate comprises a top plate, a first lateral plate and a second lateral plate, the top plate and the first lateral plate and the second lateral plate together form an accommodating cavity for containing a battery module, the top plate is arranged at the top of the accommodating cavity, the first lateral plate and the second lateral plate are respectively arranged at two sides of the accommodating cavity, both the first lateral plate and the second lateral plate are of a hollow cavity structure, the gas-liquid phase change medium is contained in the hollow cavity structure, the condensation plate is arranged above the top plate and forms a cavity together with the top plate, the cavity and the hollow cavity structure are communicated with each other.

2. The thermal management system of the battery pack according to claim 1, characterized in that: the system further comprises a division plate, the division plate is arranged in the hollow cavity structure of the first lateral plate and the second lateral plate, the division plate divides the hollow cavity structure into a plurality of cooling grooves, each cooling groove is communicated with the cavity.

3. The thermal management system of the battery pack according to claim 2, characterized in that: the system further comprises a lower baffle, the lower baffle is arranged at the top plate, which separates the cavity into a plurality of liquid separating areas, each liquid separating area is communicated with the cooling groove, a gap exists between the lower baffle and the condensation plate.

4. The thermal management system of the battery pack according to claim 3, characterized in that: the system further comprises an upper baffle, the upper baffle is arranged on the condensation plate, a gap exists between the upper baffle and the top plate.

5. The thermal management system of the battery pack according to claim 2, characterized in that: the system further comprises a balance hole, the balance hole is provided at the division plate, and the balance hole connects through the cooling grooves at two sides of the division plate.

6. The thermal management system of the battery pack according to claim 5, characterized in that: all the balance holes are of equal height.

7. The thermal management system of the battery pack according to claim 3, characterized in that: the system further comprises a separation plate, the separation plate is arranged in the cavity, which divides the cavity into an independent first cavity and second cavity, the first cavity is communicated with all the cooling grooves of the first lateral plate, the second cavity is communicated with all the cooling grooves of the second lateral plate.

8. The thermal management system of the battery pack according to claim 7, characterized in that: the system further comprises a cover of a filling opening and a filling opening, the filling opening is provided on the condensation plate, the cover of the filling opening is sleeved on the filling opening, the filling opening is communicated with the liquid separating area.

9. The thermal management system of the battery pack according to claim 8, characterized in that: the filling openings are multiple, which are arranged corresponding to the first cavity and the second cavity, respectively.

10. The thermal management system of the battery pack according to claim 1, characterized in that: the condensation plate is fixedly connected with the top plate through welding.
